(19) United States
(12) Patent Application Publication
(10) Pub. No.: US 2026/0078884 A1
(43) Pub. Date: Mar. 19, 2026

(54) LIGHTING DEVICE FOR MOTOR VEHICLES AND METHOD OF MANUFACTURE

(71) Applicant: HELLA GMBH & CO. KGAA, Lippstadt (DE)

(72) Inventors: Frank Hemker, Lippstadt (DE); Martin Hunolt, Lippstadt (DE); Wolfgang Kloppenburg, Büren (DE); Ralf Spiekermann, Lippstadt (DE); Hans Henry Vogeler, Lippstadt (DE)

(21) Appl. No.: 19/328,616

(22) Filed: Sep. 15, 2025

(30) Foreign Application Priority Data
Sep. 17, 2024 (DE) 102024126706.2

(51) Int. Cl. F21S 41/24; B60Q 1/00

(52) U.S. Cl. CPC F21S 41/24; B60Q 1/0017; B60Q 2400/20

(57) ABSTRACT

The invention relates to a lighting device for motor vehicles with a light source for emitting light and with a light guide for the transmission of the light along a light guide direction, containing a light coupling surface at which light emitted by the light source can be coupled, and a light decoupling surface, at which light coupled into the light guide can be decoupled, wherein the light coupling surface is provided with a color filter for changing the color of the light coupled into the light guide, wherein the color filter is designed as a color print coating.

### CROSS-REFERENCE TO RELATED APPLICATIONS

The present application claims the benefit of German Patent Application No. 10-2024-126-706.2, filed Sep. 17, 2024, the disclosure of which is incorporated by reference.

### FIELD OF THE INVENTION

The invention relates to a lighting device for motor vehicles with a light source for emitting light and with a light guide for the transmission of the light along a light guide direction, containing a light coupling surface at which light emitted by the light source can be coupled, and a light decoupling surface at which light coupled into the light guide can be decoupled, wherein the light coupling surface is provided with a color filter for changing the color of the light coupled into the light guide. The invention also relates to a method for generating a color filter on a light coupling surface of a light guide which is used to generate a signaling light function in a motor vehicle.

### BACKGROUND OF THE INVENTION

A lighting device for motor vehicles is known from EP2886938B1, which comprises a light source and a light guide arranged inside a housing. The housing is covered by a transparent light panel. The light guide is designed as elongated. On one narrow side, light emitted by the light source is coupled into the light guide at a light coupling surface and decoupled on a light decoupling surface arranged on the side facing the light panel. To ensure that the light is emitted in a predetermined light color to generate a predetermined signal color, the light coupling surface of the light guide is provided with a first color filter and the light panel with a second color filter. By combining these different color filters, light of a specified light color can be emitted. If, for example, a direction indicator light is to be generated, the first color filter has a pink color and the second color filter has a green color, so that a resulting orange light is emitted by superimposition. The disadvantage of forming the color filter on the light input surface is that a chemical vapor deposition process or physical vapor deposition process is used to coat the color filter, which is relatively expensive.

### SUMMARY OF THE INVENTION

The objective of the present invention is to further develop a lighting device and a method for motor vehicles in such a way that the lighting device appears in a predetermined light color in a simple manner. To solve this problem, the invention is characterized in connection with the current embodiments, in that the color filter is designed as a color print coating.

The particular advantage of the invention is that the lighting device appears in a predetermined light color in a simple manufacturing process. According to the invention, a color filter is only produced by printing on a light coupling surface of a light guide, so that the color appearance of the light guide itself is determined by this. If the actual light guide, with the exception of the coating on the light coupling side, is made of a crystal-clear material, only the light guide appears in the light color specified by the color filter, namely on its light decoupling surface. The basic idea of the invention is to define and determine the color appearance of the light guide by means of an appropriately printed color filter on the light coupling surface. This can be advantageous, for example, for the light guide to appear in an ambient appearance, for example by printing a blue color filter.

According to a further development of the invention, the color printing coating is applied to the light coupling surface of the light guide by means of a printing stamp, which is provided with the specified print color on the end face. The printing stamp has such a printing surface that the entire light coupling surface of the light guide is provided with the print color. The advantage of this is that color can be applied evenly.

According to a preferred embodiment of the invention, the light coupling surface of the light guide is flat, so that the print color can be applied evenly over a large area by a printing stamp with a flat end face. According to a further development of the invention, the color print coating is applied by printing the same print color several times, so that a sufficiently thick layer of color can be applied to the light coupling surface of the light guide.

According to a further development of the invention, the light guide is elongated and the light coupling surface is arranged on one end side of the light guide. The area of the light coupling surface is relatively small compared to the light decoupling surface, so that the color printing effort is relatively low.

According to a further development of the invention, the light guide extends in an arc along a light guide direction, with a light decoupling surface running along the arc. In this way, an elongated linear colored light line can be generated, which is particularly suitable for ambient lighting, preferably within a housing of the lighting device, for example within a headlight housing.

To solve the problem, the method according to the invention is characterized by the features of the current embodiments. The particular advantage of the method according to the invention is that the light guide appears in a predetermined color in a simple way by printing at least once on a light coupling surface of the light guide. This color can be used, for example, for ambient lighting within a housing of the lighting device.

Further advantages of the invention result from the further sub-claims.

### BRIEF DESCRIPTION OF THE DRAWINGS

An exemplary embodiment of the invention is explained in more detail in the figures below. In the figures:

FIG. 1 is a schematic top view of a lighting device for motor vehicles;

FIG. 2 is a perspective rear view of a light guide of the lighting device;

FIG. 3a illustrates a printing method of the light guide, wherein a printing stamp wetted with a coating color is moved towards the light guide perpendicular to a light coupling surface of the light guide;

FIG. 3b illustrates the printing method when the stamp makes contact with the light coupling surface of the light guide;

FIG. 3c illustrates a work step of the printing method after the first removal of the printing stamp from the printed light coupling surface of the light guide; and

FIG. 3d illustrates a further work step in the printing method after printing three times and removing the printing stamp from the printed light coupling surface of the light guide.

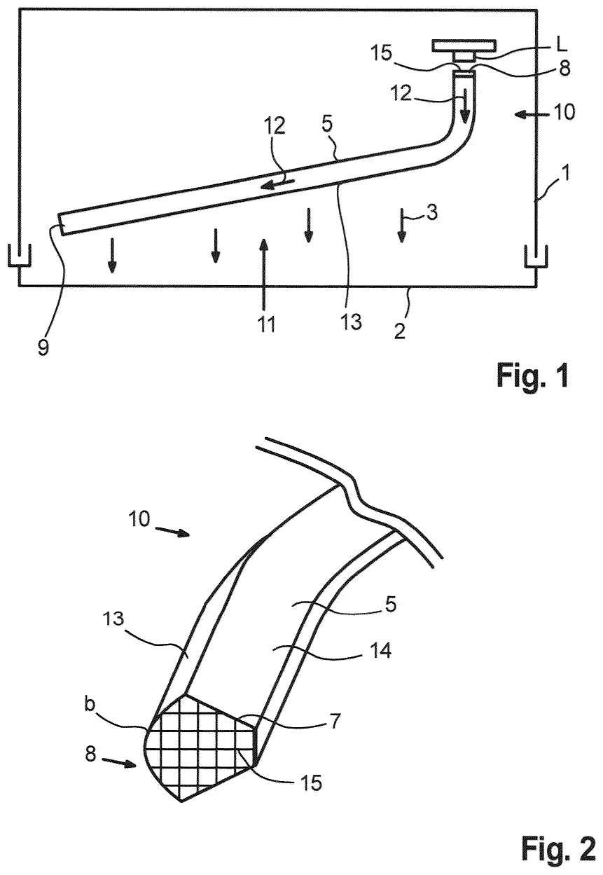

### DETAILED DESCRIPTION OF THE CURRENT EMBODIMENTS

A lighting device for motor vehicles essentially has a pot-shaped housing 1, the opening of which is covered by a transparent light panel 2. Within the interior space formed by the housing 1 and the light panel 2, light modules not shown can be arranged to generate a predefined light distribution, for example low beam distribution and/or high beam distribution. In addition, as shown in FIG. 1, a light source 4 emitting white light 3 and a light guide 5 assigned to the same light guide are arranged to generate ambient light of a predetermined light color. The lighting device thus generates a signaling light function.

The light source 4 is designed as an LED light source that emits light of a white light color. The light source 4 is preferably arranged on a printed circuit board, not shown, on which other light sources for other light modules are also arranged.

The elongated light guide 5 has a truncated cone-shaped cross-section with a semi-circular arc contour 6 and a truncated cone-shaped base contour 7. This contour 6, 7 extends continuously from a first end side 8 of the light guide 5 to an opposite second end side 9 of the light guide 5.

The first end side 8 of the light guide 5 is a light coupling surface of the light guide 5. The light source 4 is arranged in the vicinity of this light coupling surface 8 and is aligned with the light guide 5 in such a way that the light 3 emitted by the light source 4 essentially strikes the light coupling surface 8.

In the present design example, the light guide 5 has two sections. On the one hand, a first curve section 10, which is arranged on a side facing the light coupling surface 8 and extends from the light coupling surface 8 in an acute or right-angled arc.

Furthermore, the light guide 5 has a second longitudinal section 11, which directly adjoins the curved section 10 and is connected to it in one piece. While in the curved section 10 the light coupled in by the light coupling surface 8 is only transmitted in the direction in which the light guide 5 extends, i.e., in a light guide direction 12 of the light guide 5, the coupled light is not only transmitted in the longitudinal section 11 in the light guide direction 12, but is additionally deflected along the light guide 5 at a steep angle to the surface formed by the semicircular arc contour 6 by means of decoupling elements not shown, so that the coupled light is decoupled at an elongated light decoupling surface 13 of the light guide 5. The light decoupling surface 13 has a semi-circular arc contour 6 in its cross-section.

Together with the non-light decoupling surface 14, which has the truncated cone-shaped base contour 7 in its cross-section, the light decoupling surface 13 forms a lateral surface of the light guide 5.

According to the invention, it is provided that the light coupling surface 8 of the light guide 5 is provided with a color filter 15. The color filter 15 is designed as a color print coating, which is formed by one or more color print layers 16.

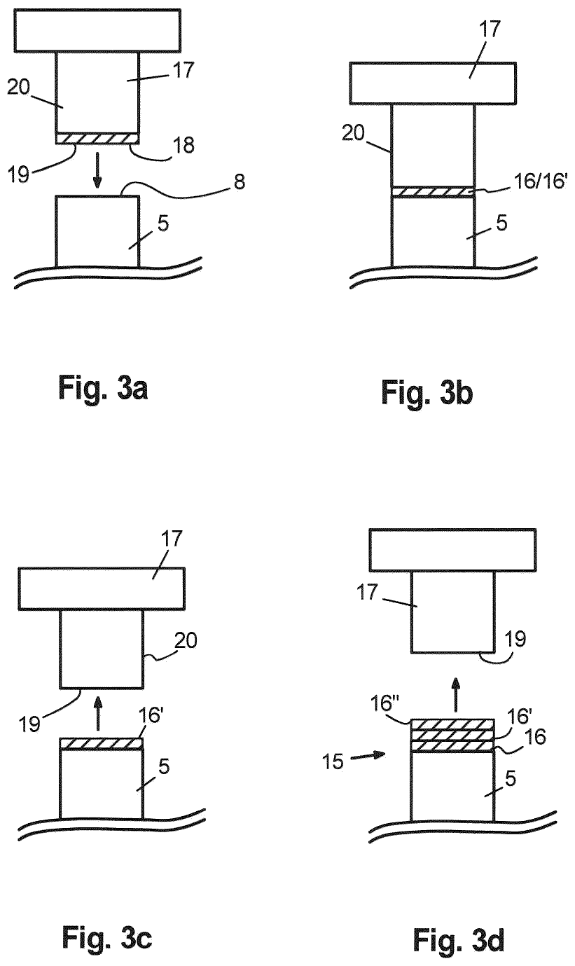

To form the color print coating 16, a printing stamp 17 is wetted with a print color 18 on its end side, see FIG. 3a. The print color 18 can be a coating color. To create ambient lighting, the print color 18 can be a blue print color, for example.

The printing stamp 17 can be rigid or flexible.

In the present embodiment example, the printing stamp 17 is rigid, with an end face 19 of the printing stamp 17 being designed to be just as flat as the light coupling surface 8 of the light guide 5 on the one hand and having the same truncated cone shape as the light coupling surface 8 of the light guide 5, so that when pressure is applied to the light coupling surface 8 in a contacting state as shown in FIG. 3b, the lateral surface 20 of the printing stamp 17 is arranged flush with the lateral surface of the light guide 5.

It is assumed that the light guide 5 is rigidly arranged in a carrier not shown. After applying pressure to the printing stamp 17 on the light coupling surface 8 of the light guide 5 and removing the printing stamp 17 from it, a first color layer 16 is applied to the light coupling surface 8. The printing process can be repeated several times by repeatedly applying print color 18 to the end face 19 of the printing stamp 17, so that several print layers, for example three print layers 16, 16′, 16″, are applied to the light coupling surface 8 of the light guide 5. This ensures a color-sealed print color application on the light coupling surface 8 of the light guide 5.

The print color 18 has, for example, blue color pigments to form a blue light color. Alternatively, any other desired color can be applied to the light coupling surface 8 of the light guide 5.

According to an alternative embodiment not shown, the light guide 5 can also be designed as a surface light guide in which light is coupled on one narrow side and light is decoupled on a large-surfaced light decoupling surface (edge light). While the light coupling is linear, the light decoupling takes place in a two-dimensional surface, i.e., not linear.

### LIST OF REFERENCE SYMBOLS

1 housing
2 lens
3 light
4 light source
5 light guide
6 arc contour
7 base contour
8 first end side/light coupling surface
9 second end side
10 curved section
11 longitudinal section
12 light guide direction
13 light decoupling surface
14 non-light decoupling surface
15 color print coating
16, 16′, 16″ color print layers
17 printing stamp
18 print color
19 end face
20 lateral surface

The above description is that of a current embodiment of the invention. Various alterations and changes can be made without departing from the spirit and broader aspects of the invention. This disclosure is presented for illustrative purposes and should not be interpreted as an exhaustive description of all embodiments of the invention or to limit the scope of the claims to the specific elements illustrated or described in connection with these embodiments. Any reference to elements in the singular, for example, using the articles “a,” “an,” “the,” or “said,” is not to be construed as limiting the element to the singular.

1. A lighting device for a motor vehicle comprising:
a light source for emitting light; and
a light guide for transmitting the emitted light along a guide direction, the lighting guide including: (i) a light coupling surface at which the emitted light can be coupled, and (ii) a light decoupling surface at which the emitted light coupled into the light guide can be decoupled;
wherein the light coupling surface is provided with a color filter for changing the color of the emitted light, the color filter being a color print coating.

2. The lighting device of claim 1, wherein the color print coating is applied via a printing stamp, the end face of which is equal to or larger than the light coupling surface.

3. The lighting device of claim 1, wherein the light coupling surface is flat.

4. The lighting device of claim 1, wherein the color print coating has a diffusing structure.

5. The lighting device of claim 1, wherein the light guide is elongated and the light coupling surface forms an end of the light guide.

6. The lighting device of claim 1, wherein the color print coating comprises a plurality of print layers each having the same color coating.

7. The lighting device of claim 1, wherein the light source is an LED light which emits white light.

8. The lighting device of claim 1, wherein the color print coating comprises blue color pigments for producing a blue color.

9. The lighting device of claim 1, wherein the light guide has a curved section along the light guide direction, the curved section having the light coupling surface at its free end.

10. The lighting device of claim 9, wherein the light guide has a longitudinal section which is integrally connected to the curved section, wherein the emitted light is deflected through a light decoupling surface arranged on one side of the longitudinal section in accordance with a light color predetermined by the color print coating.

11. The lighting device of claim 1, wherein the light guide has a truncated cone shape in its cross-section.

12. The lighting device of claim 1, wherein the light decoupling surface of the light guide is formed by a surface which has a semicircular arc contour in its cross-section.

13. A method for producing a color filter on a light coupling surface of a light guide, the light guide being configured to produce a signaling function in a motor vehicle, the method comprising printing at least one color print layer on the light coupling surface of the light guide.

14. The method of claim 13, wherein the at least one color print layer is a plurality of color print layers each with the same print color.
